(19) United States
(12) Patent Application Publication
(10) Pub. No.: US 2006/0186611 A1
(43) Pub. Date: Aug. 24, 2006

(54) Non-slip reverse device for impacting-type chuck

(76) Inventors: Robert S. Gehret, Hampstead, MD (US); Daniel Puzio, Baltimore, MD (US); Warren A. Ceroll, Owings Mills, MD (US)

Correspondence Address: HARNESS, DICKEY & PIERCE, P.L.C., P.O. BOX 828, BLOOMFIELD HILLS, MI, 48303, US

(21) Appl. No.: 11/355,386

(22) Filed: Feb. 16, 2006

Related U.S. Application Data
(60) Provisional application No. 60/654,852, filed on Feb. 18, 2005.
(60) Provisional application No. 60/655,767, filed on Feb. 24, 2005.

(51) Int. Cl. B23B 31/12

(52) U.S. Cl. 279/62

(57) ABSTRACT

A self-tightening chuck mechanism is disclosed. The chuck mechanism has a jaw mechanism with a jaw elements which are slidably disposed within corresponding channels defined in a rotatable body. A threaded socket member, which is configured to be rotated in first or second directions relative to the jaw elements is rotatably disposed about and engaged with the jaw elements. An impact assembly is configured to interface with the threaded body to apply anti-rotational forces to the socket member to prevent rotation of the socket member to close the jaws when rotated in a first direction and open the jaws when rotated in a second direction. The thrust bearing is configured to apply a first set of forces to socket member when the socket member is relatively rotated in the first direction and a second set of forces when the socket member is rotated in a second direction.

### CROSS-REFERENCE TO RELATED APPLICATIONS

This application claims the benefit of U.S. Provisional Application No. 60/654,852, filed on Feb. 18, 2005 and U.S. Provisional 60/655,767 filed on Feb. 24, 2005. The disclosure of the above applications is incorporated herein by reference.

### INTRODUCTION

The present invention generally relates to a drill chuck for use with electric or pneumatic drill/drivers and more particularly to a drill chuck that employs an impacting ring to tighten or loosen the jaws of the drill chuck against the shank of a tool bit.

Impact-type drill chucks, such as those which are described in U.S. Pat. Nos. 6,247,706 and 6,729,812, the disclosures of which are hereby incorporated by reference as if fully set forth in their entirety herein, employ an impacting ring that may be axially moved into a position where teeth on the impacting ring strike corresponding teeth that are formed on a socket that threadably engages the jaws of the drill chuck.

With reference to FIG. 1, one such prior art drill chuck is generally indicated by reference numeral 1000. The drill chuck 1000 includes a spindle 1020, a plurality of jaw members 1022, a threaded socket 1024, a socket cover 1026, an impact assembly 1028, a cover shell or housing 1030, and a sleeve 1032.

The spindle 1020 can have a forward section 1040, a collar 1042 and a rearward section 1044. The forward section 1040 can have a center through hole 1046 formed therein, while the collar 1042 can have a plurality of angularly disposed guide channels 1048 formed therethrough which intersect the center through hole 1046. The rearward section 1044 can have a threaded hole 1050, which is adapted to threadingly engage an output spindle of a power tool (not shown), and a snap ring groove 1051.

The jaw members 1022 can be slidably positioned in the guide channels 1048 and can each include a threaded surface 1052, which is formed on an outer side, and a gripping surface 1054, which is formed on a forward inner surface.

The threaded socket 1024 can be disposed about the spindle 1020 and can have an internally tapered and threaded surface 1053 that is threadably coupled with the threaded surfaces 1052 of the jaw members 1022. A plurality of recessed holes 1058 may be formed about the exterior of the threaded socket 1024, while a plurality of socket teeth 1060 can be formed on the bottom surface of the threaded socket 1024.

The socket cover 1026 can be mounted about the forward section 1040 of the spindle 1020 and can contact the threaded socket 1024 on a side opposite the socket teeth 1060. The impact assembly 1028 can include a spring 1070, an impacting ring 1072 and a joint member 1074.

The impacting ring 1072 can include an annular body 1080, one or more axially-extending guide members 1082 that can be coupled to the annular body 1080, and a plurality of ring teeth 1092 that extend from a forward side of the annular body 1080. The guide member 1082 can include a tooth-like projection 1086 having tapered sides 1088. The ring teeth 1092 are configured so as to be capable of engaging the socket teeth 1060, as will be described in detail, below.

The spring 1070 can be disposed about the spindle 1020 and can abut joint member 1074 on the rearward side. The forward side of the spring 1070 can abut the rearward side of the body 1080 of the impacting ring 1072 and bias the impacting ring 1070 toward the threaded socket 1024.

A bearing ring 1100 and bearing washer 1102 can be disposed between the impacting ring 1072 and collar 1042 of the spindle 1020. The cover housing 1030 can include a bottom cover shell 1110 and a top cover shell 1112. The bottom cover shell 1110 can be generally container shaped, having a through opening for receiving the spindle 1020 and legs 1075 of the joint member 1074 therethrough. The bottom cover shell 1110 can include a plurality of grooves 1120 into which the guide members 1082 of the impacting ring 1072 can be received. Construction in this manner permits the impacting ring 1072 to move axially but not rotatably relative to the bottom cover shell 1110, which is nonrotatably connected to the drill housing (not shown) via legs 1075 of joint member 1074.

The top cover shell 1112 can also be generally container shaped, having a through hole for receiving the spindle 1020 therethrough. The top cover shell 1112 can define a flange 1122, which can abut the socket cover 1026 on a first side and the sleeve 1032 on an opposite side. The rear edge 1126, of the top cover shell 1112 can define a plurality of shallow and deep locking recesses 1132 and 1134, respectively, which are configured to receive the projections 1086 of the guide members 1082.

The sleeve 1032 can have a positioning member 1140 and a stop flange 1144. The positioning member 1140 can have a cylindrical through-hole and a plurality of positioning ridges 1146 that extend radially inwardly so as to engage the forward section 1040 of the spindle 1020. A bearing ring 1150 and bearing washer 1148 can be disposed between the stop flange 1144 and the flange 1122 on the top cover shell 1112.

When a drill bit 1160 is to be chucked in the drill chuck 1000, the top cover shell 1112 of the housing 1030 is rotated to align the projections 1086 on a guide member 1082 with a plurality of deep locking recesses 1134 in the top cover shell 1112 so that the spring 1070 may urge the impacting ring 1072 forwardly so that the ring teeth 1092 engage the socket teeth 1060 to thereby resist relative rotation between the impacting ring 1072 and the threaded socket 1024. Subsequent rotation of the spindle 1020 in a first rotational direction causes relative rotation between the spindle 1020 and the threaded socket 1024 that drives the jaw members 1022 toward the rotational axis of the spindle 1020 and tightens the jaw members 1022 against the shank 1162 of the drill bit 1160. Continued rotation of the spindle 1020 and jaws 1022 will cause the socket 1024 to begin to rotate with the spindle 1020, causing the socket teeth 1060 to ride over the ring teeth 1092 and urge the impacting ring 1072 in a rearward direction away from the threaded socket 1024. Since the spring 1070 biases the impacting ring 1072 forwardly, the socket teeth 1060 will periodically strike the ring teeth 1092 as the threaded socket 1024 rotates. The impact of the socket teeth 1060 and the ring teeth 1092 will generate a torque that is applied to the threaded socket 1024 and that tends to further tighten the threaded socket 1024 against the jaw members 1022.

When the chuck 1000 is to be used in a drilling or driving operation, the top cover shell 1112 of the housing 1030 is rotated to align the projections 1086 on the guide members 1082 with the plurality of shallow locking recesses 1132 that are associated with the top cover shell 1112. Thus aligned, impact ring 1072 is forced rearwardly so that the set of ring teeth 1092 are disengaged from the socket teeth 1060. Accordingly, rotation of the socket 1024 is not inhibited by the teeth 1092 so that the socket 1024, jaws 1022 and spindle 1020 will co-rotate.

When the drill 1160 is to be removed from the chuck 1000, the top cover shell 1112 of the housing 1030 is rotated to align the series of projections 1086 on a guide members 1082 with the plurality of deep locking recesses 1134 that are associated with the top cover shell 1112 so that the spring 1070 may urge the set of teeth 1092 that are formed on the impacting ring 1072 forwardly into alignment with socket teeth 1060 that are formed on the socket 1024 to thereby resist relative rotation between the impacting ring 1072 and the threaded socket 1024. Subsequent rotation of the spindle 1020 in a second rotational direction opposite the first rotational direction causes the spindle 1020 and the socket 1024 to co-rotate such that the socket teeth 1060 periodically strike the ring teeth 1092. Contact between the socket teeth 1060 and the ring teeth 1092 generates torque that is applied to the threaded socket 1024 in a manner that tends to loosen the socket 1024 from the jaws 1022 and then stop further rotation of the socket. As the spindle 1020 continues to rotate, relative rotation between the threaded socket 1024 and jaws 1022 will cause the jaws to loosen from the drill bit 1160.

While such drill chucks have been shown to adequately hold drill bits and tool bits, difficulties have been noted with the aforementioned arrangements when such drill bits and tool bits are to be removed from the drill chuck. Specifically, the “loosening torque” that is generated is dependent upon a number of diverse variables, including the rotational speed of the spindle and differences between static and dynamic coefficients of friction.

In some situations, the variables that dictate the amount of torque that will be generated can change significantly between the time at which the drill is tightened in the chuck and the time at which the user desires to loosen the drill from the chuck. For example, the rotational speed of the spindle 1020 may be relatively lower when the drill is to be removed from the drill chuck 1000, as for example where the transmission of the drill or drill/driver has been shifted into a lower speed ratio or in the case of a battery operated tool, the battery has discharged to a point where it a relatively lower voltage input to the motor of the drill or drill/driver. In such cases, the operator may need to change the speed ratio of the drill or drill/driver into a higher speed ratio and/or replace or recharge the battery to remove the drill, which can be rather inconvenient.

The difference between static and dynamic coefficients of friction, however, tends to be somewhat more problematic. As is known, the dynamic coefficient of friction for a given material combination tends to be lower than the static coefficient of friction for that material combination. Since the amount of energy that is available to rotate the socket 1024 is related to the amount of energy that is dissipated between socket 1024 and the jaws 1022 in the form of friction, lower friction losses between the socket 1024 and the jaws 1022 will result in more applied power to the socket 1024.

Unfortunately, the coefficient of friction between the socket 1024 and the jaws 1022 is lowest when the socket 1024 is already moving relative to the jaws 1022 (i.e., when the socket 1024 is rotating and the jaws 1022 are being driven against the drill 1160) and highest when the socket 1024 is stationary relative to the jaws 1022 (i.e., when the jaws 1022 are against the drill 1160 and the operator is attempting to rotate the socket 1024 relative to the jaws 1022). Where the difference between static and dynamic coefficients of friction is significant, drill chucks of the type that are disclosed in U.S. Pat. Nos. 6,247,706 and 6,729,812 may not release the drill from the chuck without the operator's use of tools, such as wrenches and lock-out tools, that permit the operator to manually release the drill bit from the drill chuck. As those of ordinary skill in the art know, the manual release of a drill bit from a drill chuck is inconvenient.

### SUMMARY OF THE INVENTION

To overcome the deficiencies of the prior art, a number of embodiments are disclosed wherein the length of the impact assembly spring can be varied automatically (for example as between tightening and loosening) or manually (for example as selected by the operator). By shortening or lengthening the impact assembly spring, which means to increase or decrease the compression of the spring, the force exerted by the spring upon the impact ring and hence the torque exerted upon the jaws by the threaded socket can be varied. For example, in a first embodiment a chuck mechanism is disclosed having a user tightenable jaw mechanism. This mechanism has a plurality of engageable jaws, which are coupled to a rotatable socket member. An impact assembly is configured to interface with the socket member to prevent rotation of the socket member relative to a tool body. Rotation of the jaws in a first direction allows the interaction of the jaws with the socket member to close the jaws. Likewise, the jaws open when they are rotated in a second direction. The impact assembly is formed of an annular impact ring, a spring, and a spring bearing member. A mechanism is provided which is configured to position the spring at a first length when the jaws are rotated relative to the socket member in a first direction and a second length when the jaws are rotated in a second direction. The variation of the spring length varies the force applied by the rotatable member to the jaws.

In another embodiment of the invention, a chuck mechanism has a plurality of engageable jaws that are coupled to a socket member. An intermittently engageable impact bearing is configured to restrict rotation of the socket member upon activation, when the socket member is being rotated with the engageable jaws. The impact bearing is formed of an impact assembly, a spring and a first spring bearing member. The impact assembly is formed of an impact bearing ring and a second spring bearing member. The second spring bearing member is configured to axial move to adjust the force supplied from the spring to the impact bearing ring from a first spring force to a second spring force. The second spring bearing member applies the first spring force when the socket member is coupled to the impact assembly and the socket member is rotated in a first direction and the second spring force when the socket member is rotated in a second direction.

In another embodiment of the invention, a chuck mechanism is disclosed having a plurality of engageable jaw elements. The engageable jaw elements are drivable in first and second directions. A socket member is disposed about the engageable jaw elements. An impact assembly is disposed adjacent to the socket member and is configured to intermittently apply anti-rotational forces to the socket member. The impact assembly has a thrust bearing member, a spring, and a spring support member. The spring support member is axially movable from a first location to a second location. The spring has a first length when the spring support member is in its first location and a second length when the spring bearing member is in its second location. This variation of length changes the anti-rotational force applied to the socket member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded view of a prior art chuck mechanism;

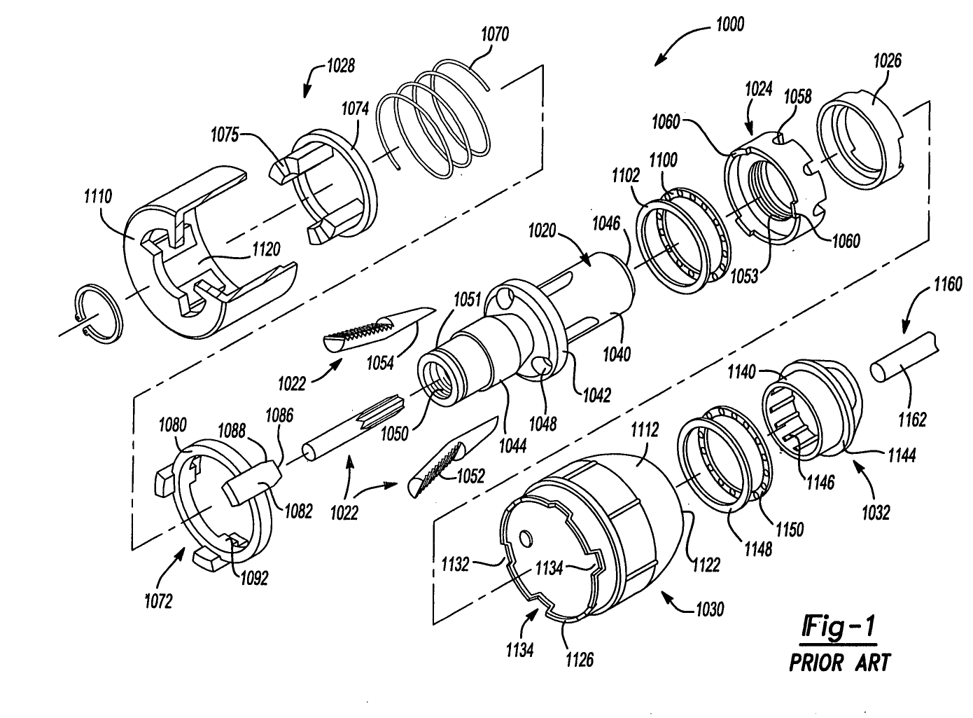

FIG. 2 is an exploded view of the first embodiment to the present invention;

FIGS. 3-6 are sectional views of the chuck shown in FIG. 2;

FIG. 7 is an exploded view of a second embodiment to the present invention;

FIGS. 8 and 9 are sectional views of the chuck mechanism shown in FIG. 7;

FIG. 10 is an exploded view of a third embodiment to the present invention;

FIGS. 11-13 represent sectional views of the chuck shown in FIG. 8;

FIG. 14 is an exploded view of a chuck according to another embodiment to the present invention;

FIGS. 15 and 16 represent sectional views of the chuck shown in FIG. 14; and

FIG. 17 represents a sectional view of an alternate chuck design.

### DETAILED DESCRIPTION OF THE PREFERRED EMBODIMENTS

The following description of the preferred embodiments is merely exemplary in nature and is in no way intended to limit the invention, its application, or uses.

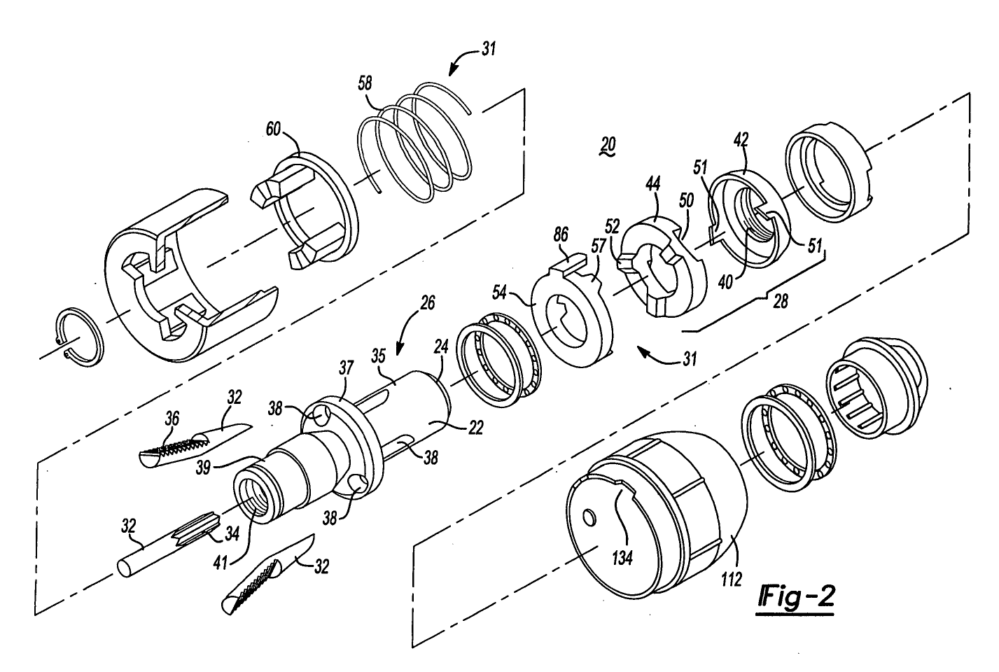

FIG. 2 represents an exploded view of a chuck mechanism 20 according to the teachings of first embodiment to the invention. The chuck 20 includes a spindle 22 defining a bit accepting through bore 24, a jaw assembly 26, a socket 28, and an impact assembly 31. Intersecting the through bore 24 are bit engaging jaw elements 32 of the jaw assembly 26. The jaw elements 32, which have a bit engaging surface 34 and a threaded drive surface 36, are slidably positioned within angularly disposed channels 38.

The spindle 22 can have a forward section 35, a collar 37 and a rearward section 39. The forward section 35 can have a center bit accepting through bore 24 formed therein, while the collar 37 can have a plurality of angularly disposed channels 38 formed therethrough which intersect the center through bore 24. The rearward section can have a threaded hole 41, which is adapted to threadingly engage an output spindle of a power tool (not shown).

The socket assembly or socket 28 is annularly disposed about the jaw elements 32. The socket 28 preferably defines an interior threaded bore 40, which is configured to interface with the threaded drive surface 36 of the jaw elements 32. Under normal operation of the tool, the socket 28 co-rotates with the jaw elements 32 and therefore does not move relative to the jaw elements 32. To tighten or loosen the jaw elements 32, the jaw assembly 26 is rotated relative to the socket 28. This can occur by holding the socket 28 fixed and rotating the jaw assembly 26.

The relative rotation of the jaw assembly 26 causes the jaw elements 32 to move together though guideways 38 when the jaw assembly 26 is rotated in a first or tightening direction with respect to the socket 28 and to disengage when the jaw assembly 26 is rotated in a second or loosening direction relative to the socket 28. The socket 28 is formed of two rings (42 and 44). The first ring 42 having the interior threaded surface 40 and a ramp interface surface 51. The second ring 44 having a ramped surface 50 configured to interface with the ramp interface surface 51 of the first ring 42 and a plurality of engagement teeth 52.

The impact assembly 31 is rotationally fixed to the body of the tool and is configured to prevent or resist rotation of the socket 28 to drive the jaws 32. The impact assembly 31 has an impact ring 54, which has a plurality of engagement teeth 57 that are configured to interface with the corresponding engagement teeth 52 of the second ring 44. The impact assembly 31 also has a spring 58 and a spring bearing element 60 which are configured to apply axial forces to the impact ring 54.

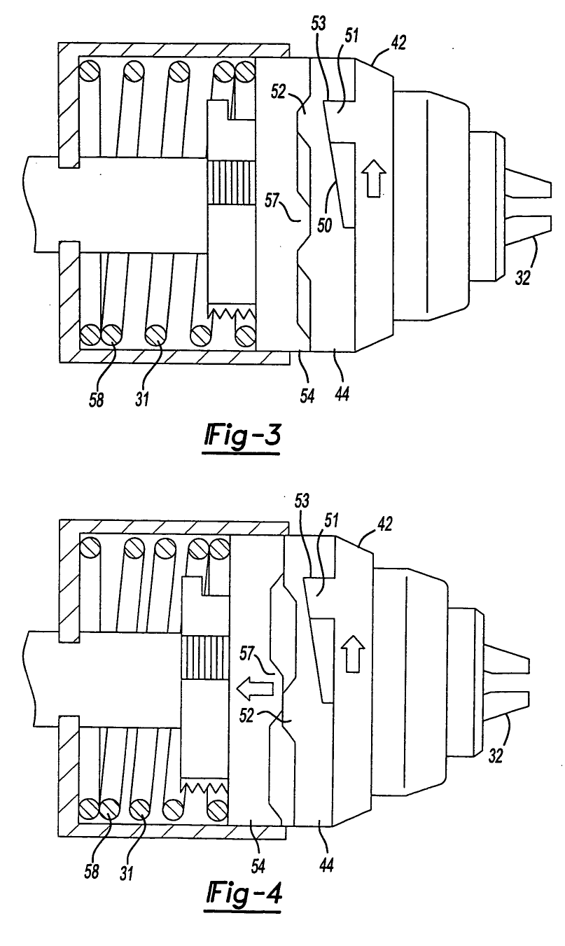

As best seen in FIG. 3 (wherein some details of the FIG. 2 embodiment have been omitted), when chucking a tool bit as described for the prior art, upon rotation of the jaw assembly 26 in the first or tightening direction, the threaded engagement between the jaws 32 and first ring 42 will initially cause first ring 42 to also rotate in the first direction. Second ring 44, however, will be restrained from rotation by the engagement between teeth 52 and teeth 57. Thus, first ring 42 will rotate relative to second ring 44 and ramped legs 51 will slide into the deep end 53 of ramped surface 50. When ramped legs 51 are in the deep end of ramped surface 50 there can be no further relative rotation between first ring 42 and second ring 44. At that point the impact ring 54 effectively engages first ring 42 via teeth 52 and 57 and via second ring 44. Since first ring 42 is then prevented from rotating, there will be relative rotation between first ring 42 and jaw assembly 26 causing jaws 32 to move inward as described for the prior art. When the jaws 32 contact the shank of the bit and can no longer move axially the orbiting jaws 32 will then force first ring 42 to rotate, which in turn will cause second ring 44 to rotate.

As shown in FIG. 4, during chucking, continued rotation of the jaw assembly 26 in the first or tightening direction will cause the rotationally coupled rings 42 and 44 to operate as in the prior art and will induce the reciprocating and impacting movement of impact ring 54 as previously described. In this preferred embodiment, however, the sloped interface 50 allows the interface ring 44 to move axially away from the spring bearing element 60 thus allowing the spring 58 to lengthen. This results in the spring 58 applying a smaller force to the impact ring 54 of the impact assembly 31. This in turn results in a reduced tightening torque applied to the jaw elements 32 and bit interface when the jaw elements are engaging a bit.

As best seen in FIG. 5, during unchucking of a drill bit, upon rotation of the jaw assembly 26 in the second or loosening direction, the threaded engagement between the jaws 32 and first ring 42 will initially cause first ring 42 to also rotate in the second direction. Second ring 44, however, will be restrained from rotation by the engagement between teeth 52 and teeth 57. Thus, first ring 42 will rotate relative to second ring 44 and ramped leg 51 will slide into the shallow end 55 of ramped surface 50. When ramped legs 51 are in the shallow end of ramped surface 50 there can be no further relative rotation between first ring 42 and second ring 44. At that point impact ring 54 effectively engages first ring 42 via teeth 52 and 57 and via second ring 44.

As seen in FIG. 6, continued rotation of the jaw assembly 26 in the second or loosening direction will cause rotationally interlocked first ring 42 and second ring 44 to initially rotate along with the jaw assembly 26. Rotation of second ring 44 will cause the socket teeth 52 to ride over the ring teeth 57 and urge the impacting ring 54 in a rearward direction away from the threaded socket 28. Since the spring 58 biases the impacting ring 54 forwardly, the socket teeth 52 will periodically strike the ring teeth 57 as the threaded socket 28 rotates. The impact of the socket teeth 52 and the ring teeth 57 will generate a torque that will eventually overcome the static friction between the first ring 42 and jaws 32, at which point the first ring will break free of the jaws. Further rotation of the jaw assembly 26 will result in relative rotation between jaws 32 and first ring 42, since rotation of first ring 42 is resisted via the interlocked second ring 44, teeth 52 and 57, and impact ring 54. The continued relative rotation between rotating jaws 32 and nonrotating first ring 42 will cause the jaws to move axially rearward and outward, thus releasing the bit from the chuck. Advantageously in this embodiment, since second ring 44 was forced rearward when ramped leg 51 moved to the shallow end 55 of ramped surface 50, spring 58 is compressed relative to its condition during chucking/tightening as described above. This results in the spring 58 applying a larger force to the impact ring 54 of the impact assembly 31 during unchucking. This in turn results in an increased loosening torque applied to the jaw elements 32 and bit interface when the jaw elements 32 are disengaging a bit.

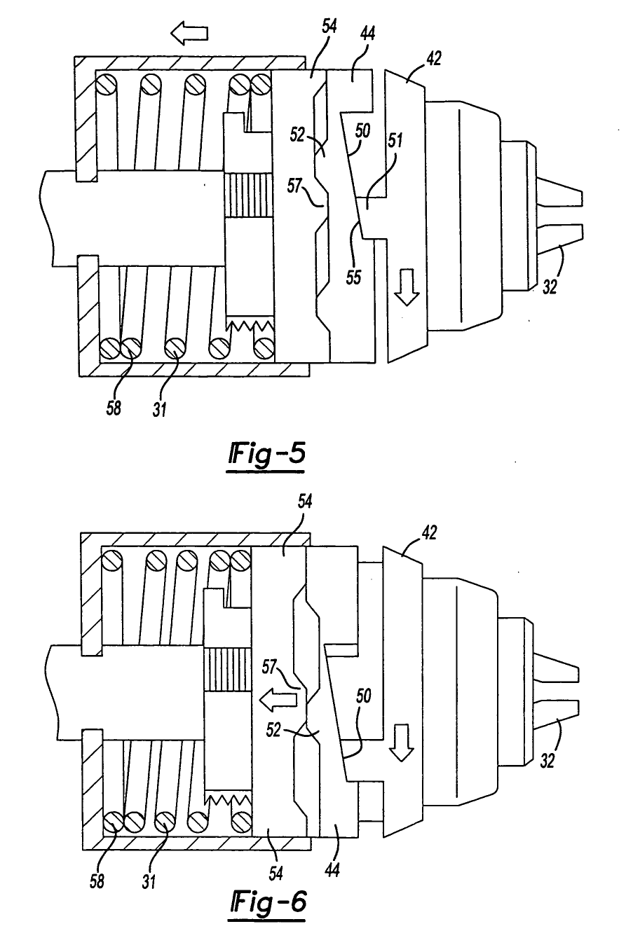

FIG. 7 represents an exploded view of the chuck assembly 70 according to another embodiment of the invention. Disposed about the spindle 22 and jaw elements 32 is a single piece socket 28. The socket 28 defines a threaded through bore 40 which is configured to interface with the threaded drive surface 36 of the jaw elements 32. The socket 28 has an interface surface 72 having a plurality of ramp engagement teeth 74. As described above, an impact assembly 80 is configured to apply relative anti-rotational forces to the socket 28. The impact assembly 80 has a impacting ring 82, and first and second spring interface members 84 and 60. Further disposed between the socket 28 and the impacting ring 82 is a biasing spring 29 that functions to separate the components when the drill is in drive mode.

When a drill bit is to be chucked in the chuck assembly 70, the top cover shell 112 of the housing is rotated to align the projections 86 on second spring interface members 84 with a deep locking recess 134 in the top cover shell 112. The spring 58 urges the impacting ring 82 through spring interface member 84, forwardly so that the ring teeth 71 engage the socket teeth 74. The engagement of the ring teeth 71 engages the socket teeth 74 thereby resisting relative rotation between the impacting ring 82 and the threaded socket 28. As the spring constant of biasing spring 29 is lower than spring 58, it is compressed.

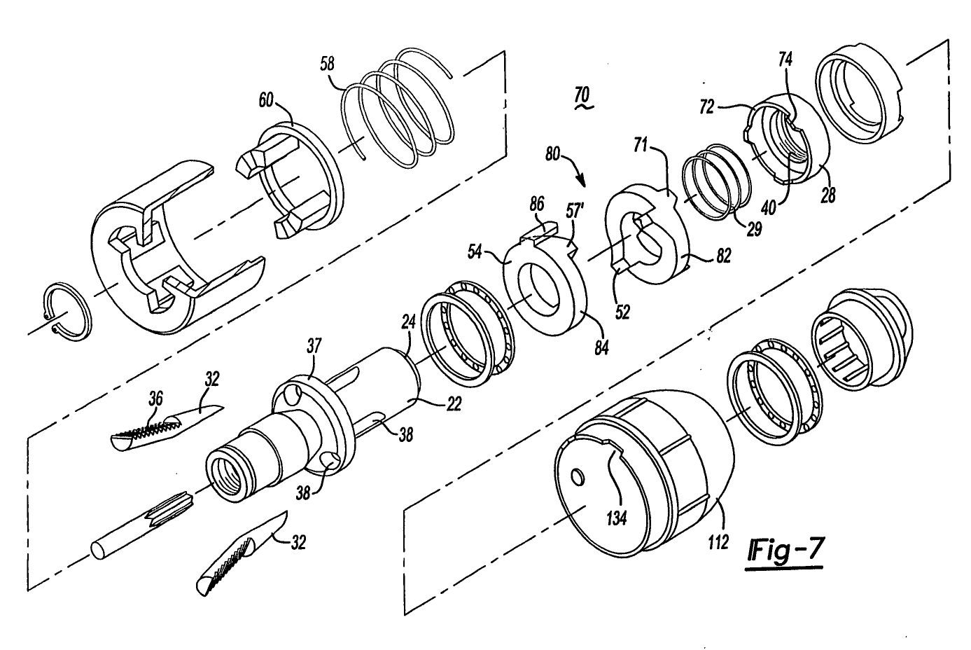

As best seen in FIG. 8, subsequent rotation of the spindle 22 in a first rotational direction causes relative rotation between the spindle 22 and the threaded socket 28 that drives the jaw members 32 toward the rotational axis of the spindle 22 and tightens the jaw members 32 against the shank of the drill bit. Relative rotation of the impacting ring 82 in the first tightening direction with respect to the first spring interface member 84 causes the impacting ring 82 and the first spring interface member 84 to move together. This allows the spring member 58 to lengthen and reduces the force applied by the spring 58 to the impacting ring 82 and, therefore, the amount of force applied by the impacting ring 82 on the socket 28. This reduces the amount of forces applied by the jaw drive's relative rotation with respect to the jaw elements 32 when the jaw elements are engaging a bit.

The first spring interface member 84, which is rotationally fixed, has a ramp surface 88 that interfaces with a corresponding ramp surface 89 on the impacting ring 82. The ramped surface can be of the form of a recess (as shown in FIGS. 8 and 9, or a projection as shown in FIG. 7). In this regard, the ramp surface 88 between the impacting ring 82 and the first spring interface member 84 are configured to allow restricted relative rotation therebetween.

As previously described, continued rotation of the spindle 22 and jaws 32 will cause the socket 28 to begin to rotate with the spindle 22, causing the socket teeth 74 to ride over the ring teeth 71 and urge the impacting ring 82 and first spring interface member 84 in a rearward direction away from the threaded socket 28. Since the spring 58 biases the impacting ring 82 forwardly, the socket teeth 74 will periodically strike the ring teeth 71 as the threaded socket 28 rotates. The impact of the socket teeth 74 and the ring teeth 71 will generate a torque that is applied to the threaded socket 28.

As best seen in FIG. 9, during unchucking of a drill bit, upon rotation of the jaws 32 and spindle 22 in the second or loosening direction, the impacting member 82 is rotated in the second direction, the first spring interface member 84 is moved away from the impacting ring 82, causing compression of the spring 58. Due to the initial frictional forces, the socket teeth 74 may be caused to ride over the ring teeth 71 and urge the impacting ring 82 and first spring interface member 84 in a rearward direction away from the threaded socket 28. Since the spring 58 biases the impacting ring 82 forwardly, the socket teeth 74 will periodically strike the ring teeth 71 as the threaded socket 28 rotates. The impact of the socket teeth 74 and the ring teeth 71 will generate a torque that is applied to the threaded socket 28. This increases the force applied from the spring 58 to the impacting ring 82. This in turn increases the amount of forces applied by socket 28 relative rotation with respect to the jaw elements 32.

The impact of the socket teeth 74 and the impacting teeth 71 will generate a torque that will eventually overcome the static friction between the socket 28 and jaws 32, at which point the socket 28 will break free of the jaws 32. Further rotation of the jaw spindle 22 and jaws 32 will result in relative rotation between jaws 32 and impacting ring 82, since rotation of impacting ring 82 is resisted via the first spring interface member 84, teeth 52 and 57. The continued relative rotation between rotating jaws 32 and non-rotating impacting ring 82 will cause the jaws 32 to move axially rearward and outward, thus releasing the bit from the chuck.

When the drill bit is to be normally driven in forward or reverse by the chuck assembly 70, the top cover shell 112 of the housing is rotated to decouple the projections 86 on second spring interface members 84 from the deep locking recess 134 in the top cover shell 112. This compresses spring 58 and allows spring 29 to urge the impacting ring 82 rearward so that the ring teeth 71 disengage the socket teeth 74 to thereby allowing rotation of the threaded socket 28 with the jaw elements 32.

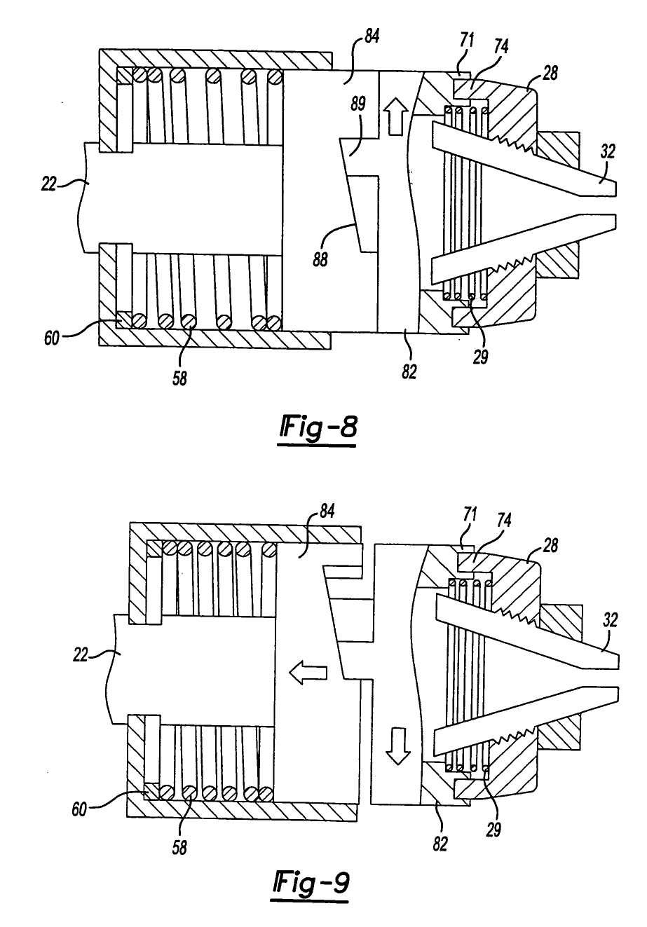

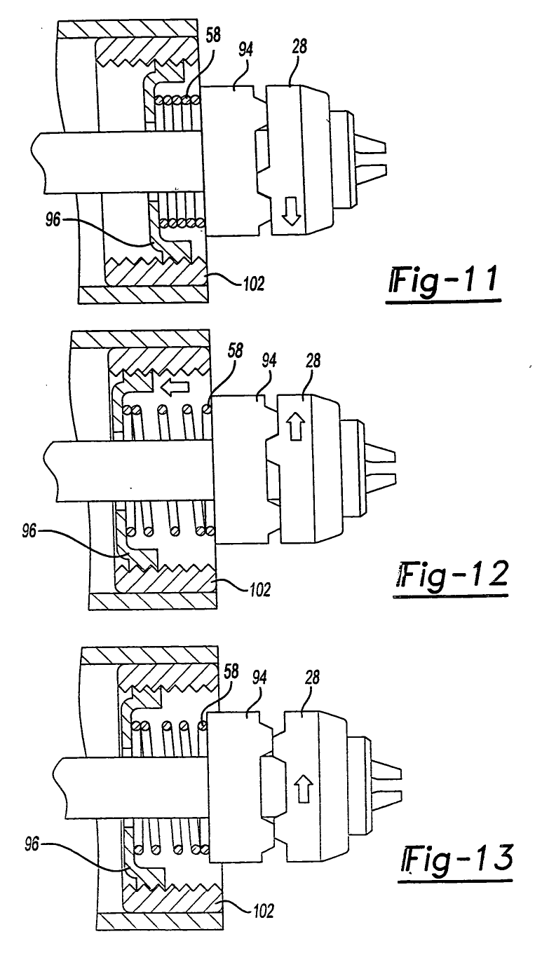

With general reference to FIGS. 10 and 14, which represent chuck mechanisms 90 according to another embodiment of the invention. An impact assembly 92 is configured to apply rotational forces to the socket 28 to tighten or loosen the jaws depending on the rotational direction as described above.

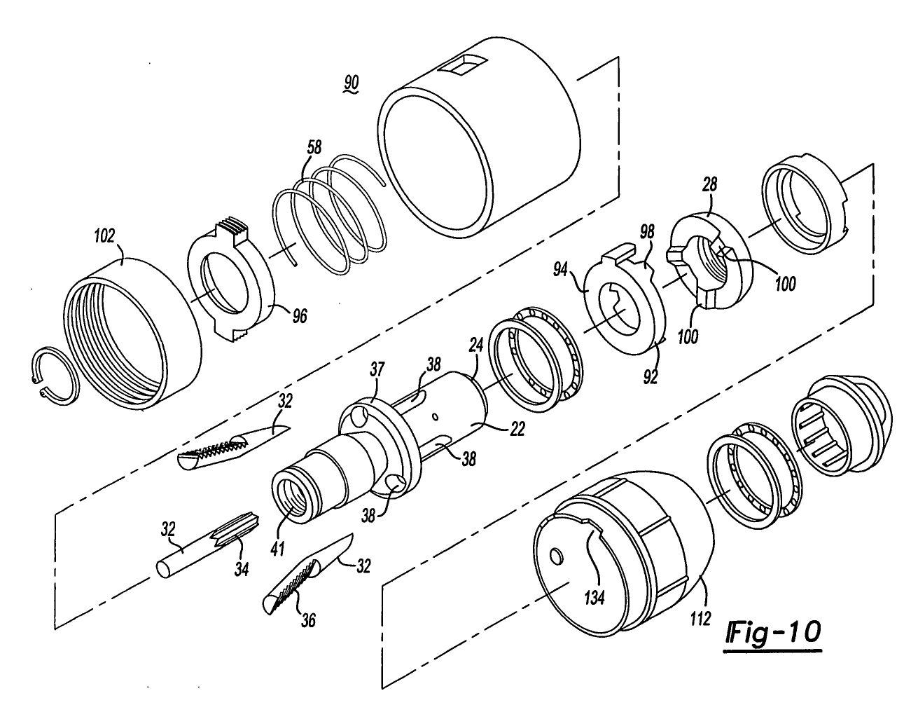

The impact assembly 92 is formed of an impacting ring 94, a spring 58, and a spring support member 96. As previously mentioned, the impacting ring 94 has a plurality of ramp engagement teeth 98 configured to interface with the corresponding teeth 100 formed in the socket 28. The spring support member 96 is axially moveable with respect to the socket 28 to alter the compression of the spring 58. As best seen in FIG. 11, the spring support member 96 can be located in a first location which compresses the spring 58 to a first length allowing the spring to apply a first force on the impacting ring 94. Alternatively, the spring support member 96 can be located in a second location (see FIG. 12), which compresses the spring 58 to a second length, to apply a second force on the impacting ring 94. As described, the first force being less than the second force.

Annularly disposed about the spring support member 96 is a threaded member 102 which can be provided to allow a user to manually adjust the axial position of the spring support member 96. Thus, rotation of the threaded member 102 allows the user to manually adjust the forces applied from the impact assembly 92 onto the socket 28 and jaw elements 32 to either tighten or loosen the jaw elements 32 with respect to the tool bit.

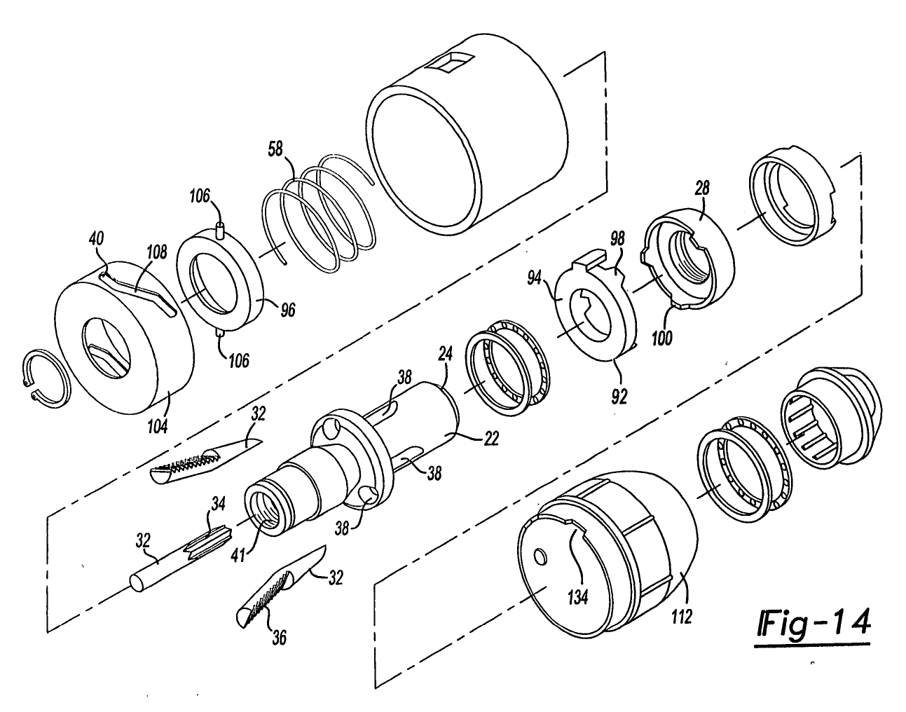

As best seen in FIGS. 14-17, the spring support member 96 can alternatively be coupled to an annularly disposed housing 104 via a pair of support cam pins 106. The support cam pins 106 are disposed within a pair of cam slots 108 formed in the support housing 104. Rotation of the spring support member 96 in a first and forward direction places the cam pins 106 of the spring support plate in a first forward axial location, thus placing a first force on the impacting ring 94.

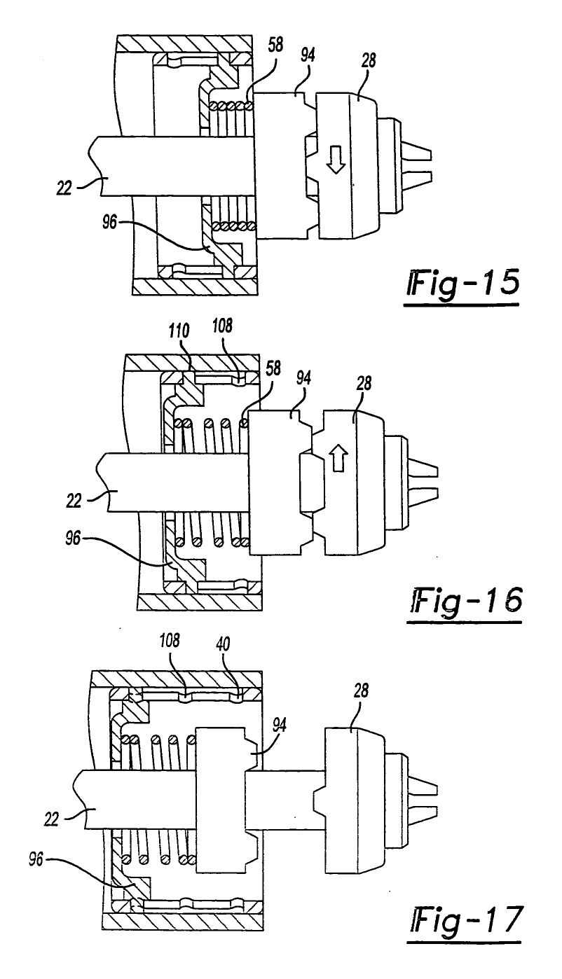

When the spring support member 96 is rotated into a second or reverse direction, the cam pins 106 of the spring support member 96 are positioned into a second location 110, thus decreasing the amount of force applied by the springs 58 through the impacting ring and socket 28 onto the threads of the jaw elements 32. As best seen in FIG. 17, the housing can optionally have a cam slot which allows complete disengagement of the impacting ring 94 from the socket 28. In this way, the spring support 96 can be used to engage or disengage the self-tightening feature of the chuck.

The description of the invention is merely exemplary in nature and, thus, variations that do not depart from the gist of the invention are intended to be within the scope of the invention. For example, it is envisioned that mechanisms can vary the amount of force applied to the thrust bearing to the self-tightening chuck assembly depending upon whether the chuck is loosening or tightening jaws. These include varying the slope of the ramps of the interface between the thrust bearing and the jaw drive. Additionally, it is envisioned that the spring assembly can be formed of a plurality of spring elements, the actuation of which dependent upon whether the tool is in a drive, tight, or loose configuration. Such variations are not to be regarded as a departure from the spirit and scope of the invention.

What is claimed is:

1. A self-tightening chuck assembly comprising:
a jaw assembly having a plurality of jaw elements, the jaw elements movable from a first disengaged to an engaged position;
a socket member configured to drive the jaw elements from the disengaged to the engaged position;
an impact assembly configured to apply anti-rotational forces to the socket member, the impact assembly having an impact ring, a spring, and a spring support member, the impact assembly configured to apply a first axial force onto the socket member when the socket member is rotated with respect to the jaw assembly in a first direction, and a second axial force when the socket member is rotated with respect to the jaw assembly in a second direction.

2. The chuck assembly according to claim 1 comprising a spring having a first length when the socket is rotated with respect to the jaw in the first direction and a second length when the socket is rotated with respect to the jaw in the second direction.

3. The chuck assembly according to claim 2 wherein the socket is formed of first and second members, said first and second members being rotatable with respect to each other from a first to a second location, said socket having a first thickness when rotated in the first direction and a second thickness when rotated in the second direction.

4. The chuck assembly according to claim 3 wherein the first and second members have engaged ramp bearing surfaces.

5. The chuck assembly according to claim 3 wherein the spring applies an axial force to the impact ring.

6. The chuck assembly according to claim 3 wherein the socket defines a plurality of first engagement teeth and wherein the impact ring has a plurality of second engagement teeth configured to engage the first engagement teeth.

7. The chuck assembly according to claim 6 wherein the first and second engagement teeth have ramped surfaces which allows axial translation of the impact ring.

8. The chuck assembly according to claim 1 wherein the impacter is configured to apply a first torsional force onto the socket when the socket is rotated in the first direction, and a second torsional force when the socket is rotated in the second direction.

9. The chuck assembly according to claim 1 wherein the spring has a fixed location at a first spring and a moveable spring interface member located at a second spring and, said moveable spring interface member being moveable from a first location to a second location.

10. The chuck assembly according to claim 9 wherein the spring interface member is rotatably coupled to the impact ring.

11. The chuck assembly according to claim 10 wherein the spring interface member defines a first ramped interface surface, and wherein the impact ring defines a second interface surface, configured to interact with the first ramped surface.

12. The chuck assembly according to claim 9 wherein the spring has a first compressed link when the spring interface member is in the first location and the spring has a second compressed link when the spring interface member is in the second location.

13. A drill chuck comprising:
a spindle that is adapted to be coupled to a source of rotational power;
a plurality of jaw members slidably supported on the spindle;
a threaded socket disposed about the spindle and threadably engaged with one of the jaw members;
a spring disposed about the spindle;
an impacting structure being disposed about the spindle and being biased towards the threaded socket by the spring, the impacting structure including a first set of teeth configured to interact with a structure on the threaded socket;
a spring support member moveable from a first location to a second location, said spring having a first compressed length when the spring support member is in the first location; and
a second compressed length when the spring support member is in the second location.

14. The drill chuck according to claim 13 wherein the spring applies a first axial force onto the impacting structure when the spring support member is in the first location and a second axial force when a spring support member is in the second location.

15. The drill chuck according to claim 13 further comprising a housing disposed about a portion of the spring, said spring support member have surface configured to interface with a complementary surface on the housing.

16. The drill chuck according to claim 15 wherein the interface surface is one of a thread or a pin.

17. The drill chuck assembly according to claim 13 wherein the impacting structure defines a plurality of first engagement teeth, and wherein the socket has a plurality of second engagement teeth configured to interface with the first engagement teeth.

18. The drill chuck assembly according to claim 17 wherein the first and second engagement teeth define engagement ramps which are configured to cause axial separation of the impacting ring with respect to the socket when the impacter structure is subjected to a predetermined torsional load.

19. A self-tightening chuck assembly comprising:
a spindle that is adapted to be coupled to a source of rotational power;
a plurality of jaw members slidably supported on the spindle;
a socket configured to drive the jaw members from a disengaged to an engaged position;
an impacter assembly configured to apply rotational forces to the socket, the impacter assembly configured to apply first torsional force onto the socket when the spindle is rotated with respect to the socket in a first direction and a second torsional force onto the socket when the spindle is rotated in a second direction.

20. The chuck assembly according to claim 19 further comprising a spring having a first compressed length when the spindle is rotated with respect to the socket in the first direction and a second compressed length when the spindle is rotated with respect to the spindle in the direction.

21. The chuck assembly according to claim 20 wherein the socket is formed of first and second members, the first and second members being rotated with respect to each other.

22. The chuck assembly according to claim 19 wherein the impacter assembly comprises an impacter ring configured to engage the socket, and the spring is configured to apply axial forces to the impacter ring.

23. The chuck assembly according to claim 19 wherein the spring has a fixed first end and a moveable spring interface member at a spring second end, said spring interface member being moveable from a first location to a second location, said spring interface member further being configured to apply axial forces to the impacter ring.

24. The chuck assembly according to claim 22 wherein the spring interface member defines a first interface ramp which is configured to interface with a second interface ramp defined on the impacter ring.

25. The chuck assembly according to claim 22 wherein the spring has a first compressed length when the spindle is rotated with respect to the socket in the first direction and a second compressed length when the spindle is rotated in the second direction.
